(19) United States
(12) Patent Application Publication
(10) Pub. No.: US 2002/0118163 A1
(43) Pub. Date: Aug. 29, 2002

(54) System for interacting of a user with an electronic system image

(76) Inventor: Mark Rozas, Reston, VA (US)

Correspondence Address: Ilya Zborovsky, 6 Schoolhouse Way, Dix Hills, NY, 11746, US

(21) Appl. No.: 09/793,554

(22) Filed: Feb. 27, 2001

(51) Int. Cl. G09G 5/00

(52) U.S. Cl. 345/156

(57) ABSTRACT

A system for interacting of a user with an electronic system image has a unit for generating an electronic system image, a unit for visually detecting positions of a body of a user without any signal emitting unit on the user's body and without user's operated control unit, a unit for determining posture parameters of the user based on the detected positions of the user's body, a unit for interacting the determined posture parameters of the user with the electronic system image, a unit for generating changes in the electronic system image as a result of the interrelating, and a displaying unit for displaying the generated changing electronic system image.

### BACKGROUND OF THE INVENTION

The present invention relates to a system for interacting of a user with an electronic system image.

Systems for interacting of a user with an electronically generated image are known in the art. In the known systems, for example of gaming type or training type, a computer generated component or game is displayed on a screen. A user utilizes joystick or keyboard and controls the user's image on the screen, which interacts with the electronically generated system or game image. For example, in a martial art training game the user generates on the screen kicks, punches, blocks, etc. so as to fight the electronically generated opponent. In accordance with another approach, markers are provided on the user's body and they emit corresponding signals which are picked up by video cameras and introduced into the system without user's operated control means, to generate on the screen the movements of the user for fighting with his opponent, participating in the game, etc. Some of such systems are disclosed for example in U.S. Pat. Nos. 5,288,078; 5,616,078; 5,913,727; and 6,005,548. It is believed that the existing systems can be further improved.

### SUMMARY OF THE INVENTION

Accordingly, it is an object of the present invention to provide an improved system for interacting of a user with an electronic system image.

In keeping with these objects and with others which will become apparent hereinafter, one feature of present invention resides, briefly stated, in a system for interacting of a user with an electronic system image, comprising means for generating an electronic system image; means for visually detecting positions of a body of a user without any signal emitting means on the user's body and without user's operated control means; means for determining posture parameters of the user based on the detected positions of the user's body; means for interacting the determined posture parameters of the user with the electronic system image; means for generating changes in the electronic system image as a result of the interrelating; and displaying means for displaying the generated changing electronic system image.

When the system is designed in accordance with the present invention, the user no longer utilizes the user's operated control means such as a joystick, a keyboard or the like and does not have to wear special markers on his body. The user just performs certain movements within a field of view of visually detecting means which detects positions of the user's body, and then posture parameters of the user based on the detected positions are determined by the determining means, so that further the determined posture parameters are interrelated with the electronically generated system image, and the display means display at least the changing electronically generated system image. In accordance with another feature of present invention, also the changing electronically generated image of the user is displayed on the display as well. In accordance with still a further feature of the present invention, the electronically generated system image can be an image which is received from a second user whose body positions were visually detected and thereafter whose posture parameters were determined as interrelated with the posture parameters of the first user. As a result two people can participate in the system with connection between the corresponding units of the first and the second users through a local network or Internet.

The novel features which are considered as characteristic for the present invention are set forth in particular in the appended claims. The invention itself however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a system for interacting of a user with an electronic system image in accordance with one embodiment of the present invention;

FIG. 2 is a view showing a system for interacting of a user with an electronic system image in accordance with a second embodiment of the present invention;

FIG. 3 is a view showing a two-dimensional determination of posture parameters of the user; and

FIG. 4 is a view showing a three-dimension of determination of posture parameters of the user.

### DESCRIPTION OF PREFERRED EMBODIMENTS

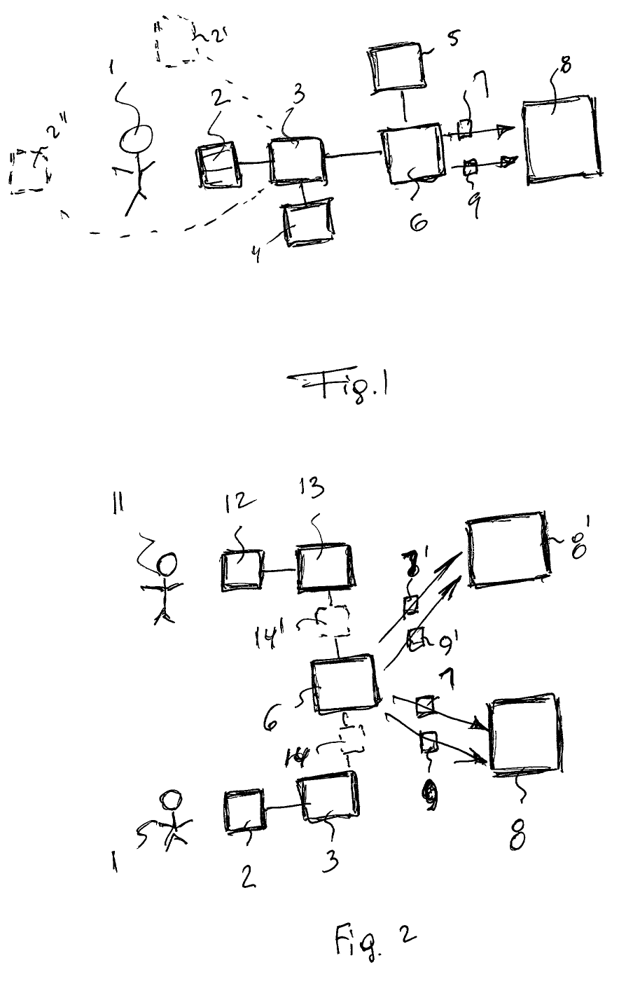

A system for interacting of a user with an electronic system image in accordance with one embodiment of the present invention is shown in FIG. 1. The reference numeral 1 identifies a user which interacts with an electronically generated image of the system. The system includes means for visually detecting positions of a body of a user, without any signal emitting markers on the user's body and without user's operated control means. The position detecting means can be formed for example as a camera, preferably as a digital camera which is identified with reference numeral 2. The visually detecting means detects positions of a body of the user and their changes over period of time.

The system further includes means for determining posture parameters of the user identified with reference numeral 3. The posture parameter determining means is connected with the visually detecting means 2 and receives signals from the latter. The determination of posture parameters of the user can be performed for example by a two-dimensional motion profile analysis. For this purpose means for supplying to the determining means a plurality of vectors identifying corresponding movements can be provided, the posture parameter determining means 3 compare the information received from the visual position detecting means 2 with the vectors, and determine the posture parameters of the user. FIG. 3 shows a position of a users arm, and a vector in which the position coincided, to therefore produce in the posture determining means 3 a corresponding signal.

The system has means for generating an electronic system image identified with the reference numeral 5. The electronic system image generating means can be any known means, such as for example means for generating an electronic virtual opponent in a martial art game, means for generating a video game, etc.

Electronic signals from the user's posture parameter determining means 3 and an electronic signal from the electronic signal image generating means 5 are supplied to interrelating means 6. In the interrelating means 6 which can be formed as artificial intelligence means, electronic comparing means, etc., the signals from the means 3 and 5 are interrelated with one another. From one output of the interrelating means 6 a signal is supplied to means 7 which generate changing electronic system image as a result of its interrelation with the signal of the posture parameters of the user. The system further includes display means which is identified with reference numeral 8. The signal from the means for generating changing electronic system image 7 are supplied to the display means 8, and the display means 8 display the changing electronic system image, for example an opponent which reacted to the user's interaction with the system, a video game which reacted to the user's intervention in the system and therefore in the video game etc. Thus, a user can see on the display means 8 the results of his movements and actions in front of the camera 2.

In accordance with another feature of present invention, the system also has means for generating changing electronic user's image 9, which is produced as a result of the interrelation of the electronic system image received from the means 5 and the electronic signal received from the user's posture parameter determining means 3.

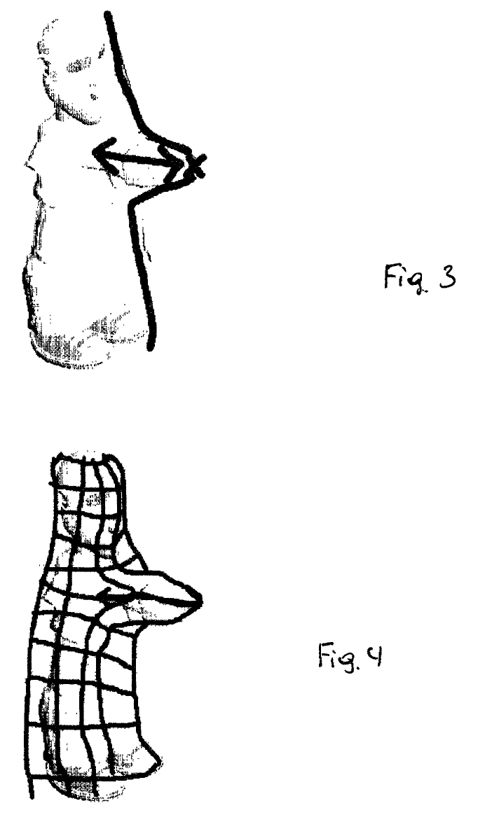

In accordance with another modification of the present invention, the position detecting means includes for example three cameras, preferably digital cameras 2, 2′, 2″ spaced from one another and each connected with the posture parameter determining means 3. The posture parameter determining means 3 in this case provides a triangulation of multiple views taken at different angles and roughly calculate three dimensional shape of the user. The triangulation can be also compared with the three dimensional vectors stored in the means 4 as shown in FIG. 4.

In accordance with still another feature of the present invention the posture parameter determining means 3 can provide a motion analysis based on coordinates of critical body points. It can employ a number of techniques to locate critical body points. For example it can rely on color differences of skin and closing to locate the hands and The system determines the critical points (head, hand, feet), and directly transposes these data for example on a cartoon figure, in which a person was animated with his own motions.

FIG. 2 shows another modification of the system in accordance with the present invention. Here, the electronically generated system image is an image produced by a second user of the system which is identified with reference numeral 11. Second means for visual detecting positions of a body of a second user 11 is identified with reference numeral 12. They are also formed without any signal emitting markers on the user's body and without user's operated control means. The signals produced by the visual position detecting means 12 are transmitted to second means for determining posture parameters of the second user identified with reference numeral 13. The posture parameters determining means 13 can operate similarly to the posture parameter determining means 3. The signal of the first user posture parameter means 3 and the signals of the second user posture parameter means 13 are supplied to the interrelating means 6 which provide electronic interrelation, for example comparison of the thusly received signals. The means 7 for generating changing electronic system image or in this case the changing electronic image of the second user supply the changing electronic image of the second user to the display means 8, and the first user can see the changing image of the second user. The means 9 generate the changing image of the first user, which can also be displayed on the display means 8.

On the other hand, at the location of the second user 11, means 7′ generate changing electronic image of the first user 1 as a result of interrelation of the posture parameters of the first user produced by the means 3 and the posture parameters of the second user produced by the means 13, and the changing electronic image of the first user is displayed on the display means 8′. It is also possible that the changing electronic image of the second user is produced by the means 9′ and also displayed on the display 8′. The users can be located a significant distance from one another. In this case the corresponding means of the system can be connected with one another through the network or the Internet as identified with reference numerals 14 and 14′.

In accordance with a further modification of the present invention, the system can generate an electronic system image, and also two users can use the system and generate images of both user's which interact with the electronic system image. The change in the electronic system image and the image of one or both user's can be displayed on the same display means or on different display means.

The inventive system can be utilized for multiple use, for example for virtual aerobic instructions, for training in martial arts, for fitness training, for playing electronic games with participation of a user, for virtual travel and exploration combined with fighting, with participation of the user, for training athletes, dancers and other professionals. The system can be installed in gyms, fitness clubs, in arcades in immersive or virtual reality arcade units, at home at a stand-alone motion capture/computing device with plugs into a television set or other display devices, and as a peripheral plug-in device for new generation

It will be understood that each of the elements described above, or two or more together, may also find a useful application in other types of constructions differing from the types described above.

While the invention has been illustrated and described as embodied in a system for interacting of a user with an electronic system image, it is not intended to be limited to the details shown, since various modifications and structural changes may be made without departing in anyway from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A system for interacting of a user with an electronic system image, comprising means for generating an electronic system image; means for visually detecting positions of a body of a user without any signal emitting means on the user's body and without user's operated control means; means for determining posture parameters of the user based on the detected positions of the user's body; means for interacting the determined posture parameters of the user with the electronic system image; means for generating changes in the electronic system image as a result of the interrelating; and displaying means for displaying the generated changing electronic system image.

2. A system as defined in claim 1; and further comprising means for generating changing electronic user's image as a result of the interrelating and connected with said display means, so that said display means display the changing electronic user's image.

3. A system as defined in claim 1, wherein said determining means are means for calculating posture parameters of the user based on the detected position of the user's body.

4. A system as defined in claim 1, wherein said means for visually detecting positions of the user's body include at least one camera, said determining means being operable for determining posture parameters of the user from signals received from said at least one camera.

5. A system as defined in claim 4, wherein said determining means is operable for receiving a plurality of vectors and comparing positions of the user's body with the vectors so as to determine the posture parameters of the user in at least two dimensions.

6. A system as defined in claim 4, wherein said determining means is operable for receiving a plurality of vectors and comparing positions of the user's body with the vectors so as to determine the posture parameters of the user in at least three dimensions.

7. A system as defined in claim 1, wherein said determining means include a plurality of cameras for visual detecting positions of the user's body from different directions.

8. A system as defined in claim 7, wherein said determining means is operative for receiving the detected positions of the user's body from said plurality of cameras and determining posture parameters of the user by triangulation.

9. A system as defined in claim 7, wherein said determining means is operative for receiving the detected positions of the user's body based on motion analysis of coordinates of critical body points of a user.

10. A system as defined in claim 1, wherein said visually detecting means includes digital camera means.

11. A system as defined in claim 1; and further comprising further means for visually detecting positions of a body of a further user without any signal emitting markers on the body of the further user or user operated control means, means for determining posture parameters of the further user based on the detected positions of the further user's body and connected with said interacting means, so that said interacting means provides interrelation of the electronic system image based on the posture parameters of the further user on the one hand and the posture parameters of the first mentioned user on the other hand.

12. A system as defined in claim 11; and further comprising means for generating changing electronic first user's image; and further display means provided at a location of the further user and displaying the changing electronic first user's image on said further display means as result of the interrelating.

13. A system as defined in claim 12; and further comprising further means for generating changing second user's image and connected with said further display means for displaying at the second user's location the changing electronic second user's image as a result of the interrelating.

14. A system as defined in claim 12; and further comprising transmitting signals from at least one of said detecting means to said interrelating means, said transmitting means being formed as network means.

15. A system as defined in claim 12; and further comprising transmitting signals from at least one of said detecting means to said interrelating means; and transmitting means being formed as Internet means.
